(19) United States
(12) Patent Application Publication
(10) Pub. No.: US 2013/0227710 A1
(43) Pub. Date: Aug. 29, 2013

(54) SYSTEM AND METHOD FOR SECURING LEASED IMAGES IN A CLOUD ENVIRONMENT

(71) Applicants: Nir Barak, Karmi Yosef (IL); Eitan Hadar, Nesher (IL)

(72) Inventors: Nir Barak, Karmi Yosef (IL); Eitan Hadar, Nesher (IL)

(73) Assignee: Computer Associates Think, Inc., Islandia, NY (US)

(21) Appl. No.: 13/406,036

(22) Filed: Feb. 27, 2012

(51) Int. Cl. G06F 21/24

(52) U.S. Cl. 726/29

(57) ABSTRACT

Provided is a system, method, and computer-readable storage medium having one or more computer-readable instructions thereon for providing leased images in cloud computing environments. The method includes monitoring a usage of a leased image provided by a cloud vendor, by a client computing device. A threshold period of time associated with the usage is determined. Whether an access to the leased image should be terminated based upon an expiry of the threshold period of time or based upon a request received from the client computing device is determined. The image is locked based upon whether the access to the leased image should be terminated. An access request received for the locked image is monitored; and access to the locked image is enabled when it is determined that the access request is valid.

### CROSS REFERENCE TO RELATED APPLICATIONS

This application is related to the following co-pending applications, filed concurrently herewith, the disclosures of which are hereby incorporated by reference in their entirety: U.S. patent application Ser. No. ______ (Attorney Docket No. 072962-0397234), entitled “System and Method for Isolated Virtual Image and Appliance Communication within a Cloud Environment,” and U.S. patent application Ser. No. ______ (Attorney Docket No. 072962-0397236), entitled “System and Method for Virtual Image Security in a Cloud Environment.”

### FIELD

The invention relates generally to the field of securing leased images in cloud computing environments, and more particularly to securing leased images in a cloud computing environments using an image reservation system.

### BACKGROUND

Cloud computing environments have turned around the manner in which business organizations examine the requirements and capacity to implement their data processing needs. A cloud computing environment may include capabilities where a cloud provider hosts hardware (and related items) and provides systems and computational power as a service to a customer (e.g., business organization). When implementing data processing needs via a cloud vendor, a customer does not need to bear the cost of space, energy, and maintenance in order to acquire the required computational resources at a reasonable cost.

The cloud provider provides images and/or image bundles to the customer. These images are essentially virtual machines that provide various applications or services to the customer. For example, a customer may require use of an application provided by a cloud vendor. However, the customer may not require a complete version of the application with all features, and may only need to use some features of the application. In such a scenario, the cloud vendor may customize the application for the customer and form an image that hosts the customized application for use by the customer, as required by the customer. Similarly, a snapshot of a database that has data for testing may be loaded onto an image and provided to a customer for use. Generally, any resource, application, or service that is supported by a cloud vendor and is provided, for example, for a limited period of time to a customer can be supported by and provided to the customer on an image. Once provided to the customer for a period of time, the image is deemed as “leased” for that period of time.

When the image provided to a customer is not being actively used by the customer, it is prudent to secure the image to prevent unauthorized use and to accurately bill the customer for active usage of the image. Failure to do so can result in unauthorized usage (e.g., by malware agents) and inaccurate billing of usage by the user. Conventionally, the end user in a cloud computing environment is responsible to shutdown or suspend the use of an image leased from a cloud vendor when not needed and secure its data. However, such reliance on the customer/user of the image to lock the image is a security issue, for example, when the user forgets to lock the image after active use making the unattended unlocked image prone to unauthorized use. Further, conventional systems are unable to accurately monitor and bill the user for only the time the leased image was actively used. For example, a dormant image that is not in use and has not been securely locked may be subject to inadvertent startup by a hosting server of a cloud vendor causing erroneous billing. Images may become dormant when not in use before a customer goes on a vacation or turns on another image and does not need the earlier leased image for a while. However, time between an image becoming dormant and a user's cessation of use may be significant.

These and other drawbacks exist.

### SUMMARY

In some implementations, these and other drawbacks of existing systems are addressed, where provided is a system, method, and computer-readable storage medium having one or more computer-readable instructions thereon for providing leased images (guest virtual machines) in cloud computing environments. The method includes monitoring a usage of a leased image provided by a cloud vendor, by a client computing device. A threshold period of time associated with the usage is determined. Whether an access to the leased image should be terminated based upon an expiry of the threshold period of time or based upon a request received from the client computing device is determined. The image is locked based upon whether the access to the leased image should be terminated. An access request received for the locked image is monitored; and access to the locked image is enabled when it is determined that the access request is valid.

Various other objects, features, and advantages of the invention will be apparent through the detailed description and the drawings attached hereto. It is also to be understood that both the foregoing general description and the following detailed description are exemplary and not restrictive of the scope of the invention.

### BRIEF DESCRIPTION OF THE DRAWINGS

FIG. 1 is an illustration of an example system for providing leased images in cloud computing environments, according to various implementations of the invention.

FIG. 2 is an illustration of an image leasing system, configured to provide leased images according to various implementations of the invention.

FIG. 3 is a flowchart depicting example operations performed by one or more components of the system, according to various implementations of the invention.

### DETAILED DESCRIPTION OF THE INVENTION

The systems and methods provided herein enable authorized repeatable use of virtual images from a cloud provider image pool, while maintaining image state in a non-active, yet secured and trusted mode, in a segregated fashion.

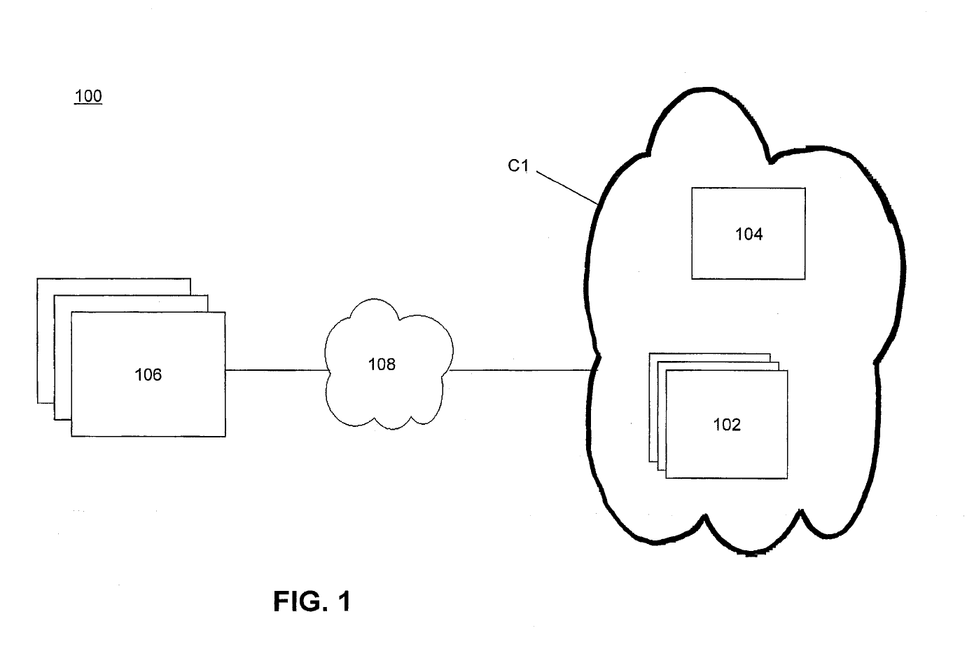

FIG. 1 is an exemplary illustration of an environment 100, which is an example of an environment wherein a system for securing transient and on-demand leasing of segregated image bundles in a virtualized cloud computing environment may reside. In some implementations, environment 100 may include, among other things, a cloud computing environment C1, one or more client devices 106, and a network 108.

In some implementations, cloud environment C1 be or include a virtual computing environment supporting one or more virtual machines. The virtual machines and other features of cloud environment C1 may include or otherwise be supported by one or more hardware computing devices having an operating system, disk drives, interfaces/ports, memory, buses, cooling sub-systems, and various software stored therein on tangible computer readable media. In some implementations, the hardware computing devices supporting cloud environment C1 may include electronic and electrical circuitry such as processors and memory and/or other hardware operable to execute computer-readable instructions using, for example, an operating system (OS). In some implementations, the hardware computing devices supporting cloud environment C1 may include one or more tangible computer-readable storage media configured to store one or more software modules, wherein the software modules include computer-readable instructions that when executed by one or more processors may cause the processors to perform the features and functions related to securing leased images, as described herein. In some implementations, the hardware computing devices supporting cloud environment C1 may comprise computer hardware programmed with a computer application having one or more software modules that enable the various features and functions related to securing leased images, as described herein. It will be appreciated that in some implementations the hardware computing devices supporting cloud environment C1 may be located remote from a physical location of the organization (e.g., on a home computer of a user within the organization's network), and various implementations of the present invention are not limited by the location of the hardware computing devices supporting cloud environment C1. Further, in some implementations, cloud environment C1 may be supported by and/or communicably coupled with a plurality of different types of hardware computing devices including but not limited to mobile computing devices. In some implementations, cloud environment C1 may be provided or operated by a cloud vendor such as, for example, Amazon.com, Inc. of Seattle, Wash., although other types of service providers (e.g., Internet-as-a-service (Iaas) providers) may be used. It is to be noted that although a single cloud environment C1 is illustrated in FIG. 1, environment 100 may include a plurality of cloud environments.

In some implementations, cloud environment C1 may provide an image leasing system for securing transient and on-demand leasing of segregated image bundles in a virtualized cloud computing environment, such as, environment 100. The image leasing system may be used by customers at one or more client devices 106 for reserving protected or unprotected images provided by cloud environment C1. As used herein, the term “image” may refer to a virtual machine operating on a cloud environment (e.g., cloud environment C1) that provides one or more services (e.g., applications, databases, or other services) to users. The term “guest virtual machine” may be used to refer to virtual machines that can be leased to user to provide such services. Accordingly, in some implementations, cloud environment C1 may include one or more guest virtual machines 102 and at least one virtual appliance machine 104.

In some implementations, network 108 may be the Internet or the World Wide Web (“www”). In some implementations, network 108 may be a switching fabric that is part of a Wide Area Network (WAN), a Local Area Network (LAN), or other types of networks known to those of ordinary skill in the art (e.g., a TCP/IP network). In some implementations, network 108 routes requests from cloud environment C1 and/or client devices 106 for accessing various resources provided by cloud environment C1. In some implementations, network 108 is used for communication between various components of environment 100 via wired, wireless, optical, or other types of communication links, known to one of ordinary skill in the art.

Client devices 106 may include computing devices known to those of ordinary skill in the art, such as, for example, desktop computing devices, laptop computing devices, server devices, mobile computing devices, smart phones, personal digital assistants (PDAs), tablet computing devices, and/or other computing devices.

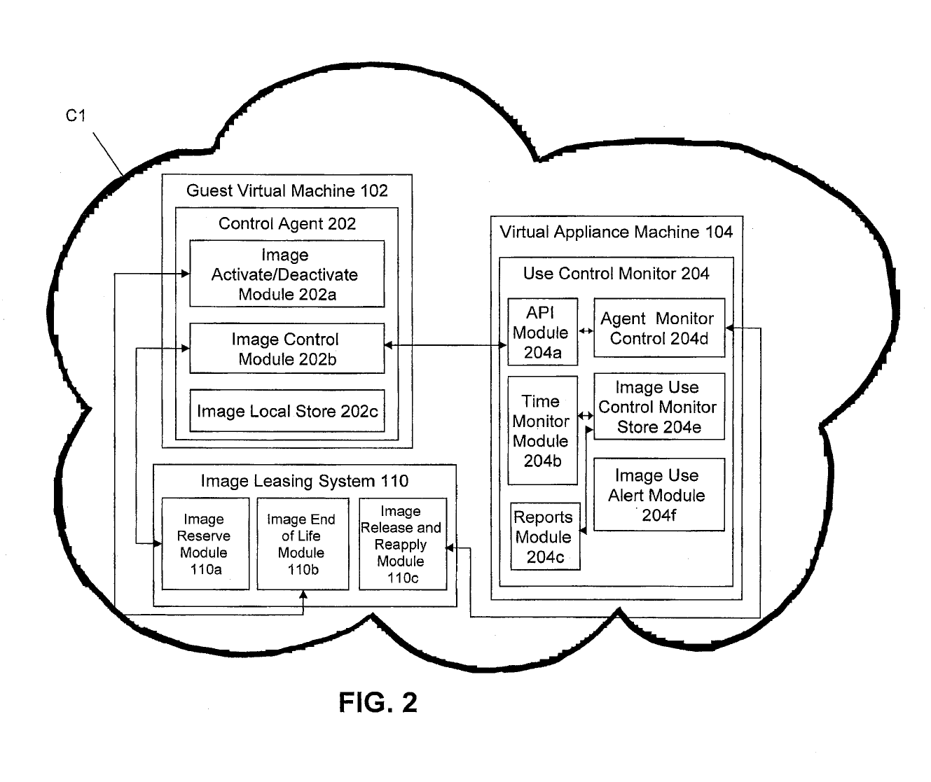

FIG. 2 illustrates an example of details of cloud environment C1 and the components thereof that provide image leasing functionality. It will be appreciated that components of cloud environment C1 can be moved around to different hardware locations as desired. Further, although a single guest virtual machine 102 is described in FIG. 2, the implementation shown in FIG. 2 can equally be carried out on any number of guest virtual machines in cloud environment C1 or other cloud environments.

In addition to guest virtual machine 102 and virtual appliance machine 104, cloud environment C1 may include an image leasing system 110 which may be or include an application module that provides leasing and reservation services for guest virtual machines (e.g., guest virtual machine 102) in cloud environment C1. In some implementations, image leasing system 110 may be or be hosted by a virtual machine of cloud environment C1. In some implementations, image leasing system 110 may be external to cloud environment C1. However, image leasing system 100 should have network access to cloud environment C1 so as to communicate requests and receive responses.

In some implementations image leasing system 110 may include one or more sub-modules or components such as, for example, an image reserve module 110a, an image end life module 110b, an image release and reapply module 110c and/or other modules or components.

In some implementations, image reserve module 110a is used by customers at one or more client devices 106 for reserving a guest virtual machine (e.g., guest virtual machine 102). In some implementations, image reserve module 110a may include or support a graphical user interface (GUI) displayed on one of client devices 106. Once reserved, the guest virtual machine is deemed as leased to the customer for a period of time determined either by a time period requested by the customer. In some implementations, the period of time may be used as a threshold for determining how long a guest virtual machine can be leased to a customer.

In some implementations, image end life module 110b is used by customers to dispose of a guest virtual machine when the life of the leased guest virtual machine ends, i.e., the guest virtual machine expires. Guest virtual machine end life is associated with terminating a guest virtual machine when the lease period is over and cloud environment C1 does not or cannot renew the lease for that guest virtual machine.

In some implementations, image release and reapply module 110c is used by customers to return a guest virtual machine before the threshold time expires, or is manually made to expire (e.g., by a customer). Threshold time is defined as a time that a customer indicates in an initial request for leasing after which the guest virtual machine will automatically lock (unless asked for an extension by the customer.

As discussed herein, “Images” or “image bundles” are defined as representations of virtual machines that run, provide, or support, one or more services (e.g., applications or other resources) on cloud environment C1 and may be referred to herein as guest virtual machines. These guest virtual machines can be accessed by client devices 106 via network 108. In some implementations, guest virtual machines on hardware memory of one or more hardware devised that support cloud environment C1 and are implemented using code residing upon such memory in coordination with one or more processor of such supporting devices. When customers wish to use such guest virtual machines, they can reserve them from cloud environment C1. At that point, the reserved machines are defined as “leased.” For example, guest virtual machine 102 of cloud environment C1 may be leased to a customer on one of client devices 106. In some implementations, guest virtual machine 102 may be one of a plurality of guest virtual machines supported by cloud environment C1. The plurality of guest virtual machines may form one or more image bundles of which at a given time are active, dormant, or in process of being activated, or de-provisioned. In some implementations, guest virtual machine 102 includes a native operating system (OS) that can be controlled by a specific control modules installed thereon such as, for example a control agent 202. By way of example only, operating systems can include open source operating systems such as UNIX, LINUX, or proprietary operating systems such as WINDOWS® provided by Microsoft Corporation of Redmond, Wash., or other native OSs that cloud environment C1 can run for which control agent 202 may be implemented for. Control agent 202 may be communicably coupled to an agent monitor control 204d of a use control monitor 204 on virtual appliance machine 104. A virtual appliance machine is another virtual machine (or image), running in cloud environment C1 that is used to run control agent 202. Virtual appliance machine 104 is used by control agent 202 to validate that guest virtual machine 102 is working only when activated, and not in between uses (locked) or after final use (deactivated/de-provisioned).

In some implementations, control agent 202 includes image activate/deactivate module 202a that is a local utility for customers connected to server device 102 to update/verify the status of its associated leased guest virtual machine. For example, the leased guest virtual machine could be in an active status where the guest virtual machine is being actively used by the customer, or the leased guest virtual machine could be in a dormant mode where it is not being actively used. In some implementations, image status can be updated/verified by using a predefined image definition during setup time. In some implementations, image status can be updated/verified by activating the status after setup using image reservation system 110 using network connection between control agent 202 and image reservation system 110.

In some implementations, control agent 202 includes an image use control module 202b that is used by control agent 202 to validate that locked or deactivated guest virtual machine 102 cannot run and therefore, cannot use cloud environment C1 as a front end. Validation entails verifying credentials associated with a particular customer for the leased guest virtual machine 102. In some implementations, image use control module 202b may also accept client requests from client devices 106 to activate, deactivate or release guest virtual machine 102, and/or check the connecting status to agent monitor control 204d on use control monitor 204.

In some implementations, control agent 202 includes an image local store 202c that is configured to store one or more electronic certificates associated with guest virtual machine 102 and local status for guest virtual machine 102, to be communicated with agent monitor control 204d on the use control monitor 204, used by image use control module 202b that validates the local image status of guest virtual machine 102. Guest virtual machine 102 may be described as an image running on a host on cloud environment C1 that can be leased for the customer. As used herein, a “host” refers to a physical host machine in cloud environment C1 that the virtual machines of cloud environment C1 run on. The certificates are electronic files storing, among other data, data about the authenticity of guest virtual machine 102. The certificates are communicated to customers so that the authenticity of guest virtual machine 102 being leased can be verified prior to active usage of the leased guest virtual machine 102. Such verification is a defense mechanism against malware laden guest virtual machine that might offered to customers by a malicious host. In some instances, the certificates are communicated to customers when a customer leases a guest virtual machine (can also be done afterwards) so the customer can provide them to the cloud environment or other administrative entity if needed to prove the customer's ownership on the guest virtual machine they have (or should have) access to. The certificates may also be saved on the virtual appliance machine which may provided certificates to stored certificates to authenticate user access or otherwise to verify identify of a guest machine. For example, if a different guest virtual machine is put in place for a given user to use, the certificate the customer has and the certificate for the new machine stored on the virtual appliance machine will not match.

In some implementations, use control monitor 204 is configured to allow receiving alerts and status on monitored guest virtual machines (e.g., guest virtual machine 102), and/or mark leased guest virtual machines that have completed their use period. In some implementations, use control monitor 204 includes, among other things, an application program interface (API) module 204a, a time monitor module 204b, a reports module 204c, agent control monitor 204d, an image use control monitor store 204e and an image use alert module 204f. In some implementations, use control monitor 204 may be installed on a virtualization host (such as ESXi® provided by VMware of Palo Alto, Calif., Hyper-v® provided by Microsoft Corporation of Redmond, Wash., or other vendors) inside a dedicated virtual machine (virtual appliance) of which use control monitor 204 is part of. As discussed herein, a virtual appliance is another virtual machine (or image) in cloud environment C1. In some implementations, use control monitor 204 is configured to serve requests from an image use control module 202b installed on any guest virtual machine running on the virtualization product host, and provide image status to control agents 202 of those machines for enforcement for scenario where guest virtual machine that should not be used.

In some implementations, API module 204a is an interface that enables agent monitor control 204d, described below, and/or use control monitor 204 to communicate with other components of environment 100.

In some implementations, time monitor module 204b is a monitoring agent for a time for which active guest virtual machine are used actively by a customer at server device 102 who leases that guest virtual machine. When a leased guest virtual machine time expires, time monitor module 204b locks the guest virtual machine to prevent use until reactivated at a later time.

In some implementations, reports module 204c includes information on use status of image use control monitor store 204e to generate reports on either alerts generated, or image status (activated, locked, or deactivated), or other information associated with leasing of guest virtual machine s. For example, such information can include a list of locked guest virtual machines, guest virtual machine s that are about to be locked, active guest virtual machine s, guest virtual machine s that were marked with alerts, and/or guest virtual machine marked to be disposed. Information on alerts can also include time stamp information to detect on cloud environment C1 instances wherein a leased guest virtual machine was attempted to be accessed at the same time an authorized user was using the same leased guest virtual machine. Using reports module 204c, image status can be used to find dormant guest virtual machines, or guest virtual machines that have not been used for a long time, or have been marked to be disposed but were not yet disposed.

In some implementations, agent monitor control 204d is a component of use control monitor 204 that gets a request from control agent 202 inside guest virtual machine 102, and answers the request indicating whether guest virtual machine 102 should run or not.

In some implementations, image use control monitor store 204e is a store for certificates and status of guest virtual machines in cloud environment C1, and specifically for use control agent 202 associated with each of guest virtual machines in cloud environment C1. Image use control monitor 204e also includes the time a leased guest virtual machine will expire and the policy governing functionalities of image leasing in cloud environment C1 in case of an alert (e.g., get the guest virtual machine down, warn, and/or send an alert and where to send it). Information in image use control monitor store 204e is used by the other components on use control monitor 204 (e.g., agent control monitor 204d described above) to carry out their respective actions. By way of example only, such actions include, getting image status based on the certificate to decide if the guest virtual machine can be started, storing a new status if status has changed (e.g., locked/unlocked), obtaining the policy to know how to react to exceptions, and/or storing a changed policy, if there was a request for such a change.

In some implementations, image use alert module 204f is a store for monitoring alerts using image use control monitor 204e. If an alert is raised inside image use control monitor 204e, image use alert module 204f reads the policy stored in image use control monitor 204e and sends alerts accordingly.

It will be appreciated that in some implementations, various modules of image leasing system 110, control agent 202, and use control monitor 204 may reside on tangible computer readable medium (e.g., a memory device) as instructions or as hardware modules such as ASIC modules, and the implementation of the systems and methods provided herein is not limited by the manner in which the modules are implemented. For example, in some implementations, the functionality of the modules may be executed by computer readable code or software written in programming languages known to one of ordinary skill in the art (e.g., C++ language).

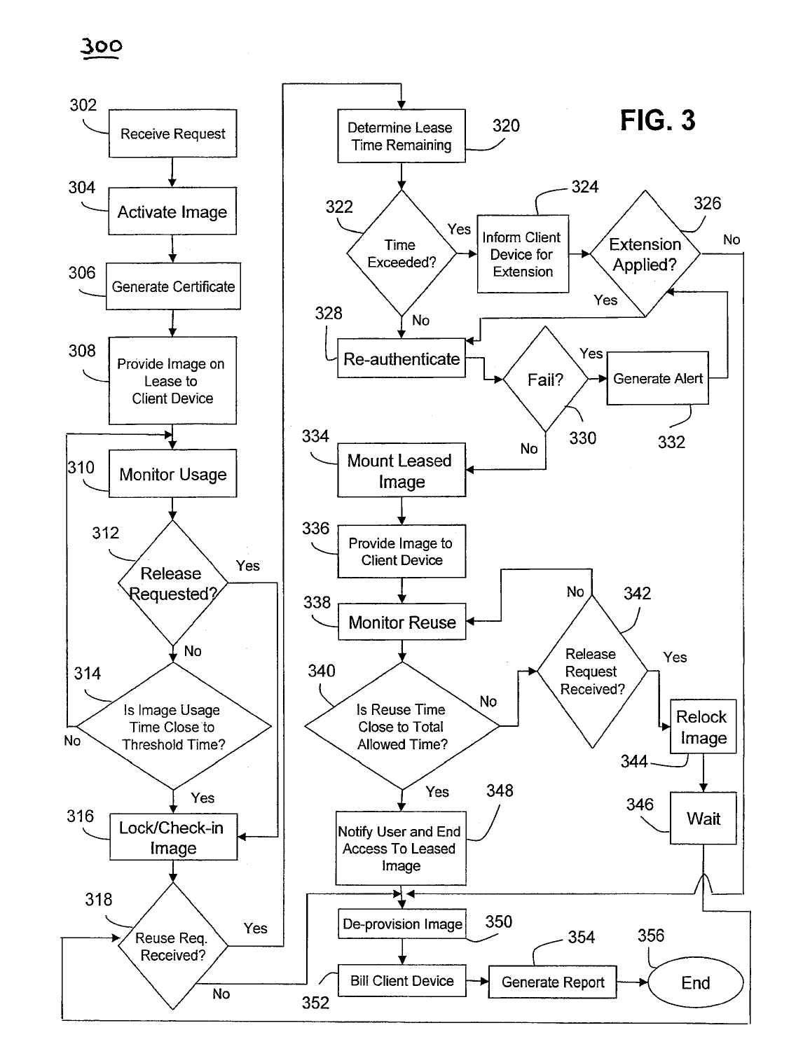

FIG. 3 illustrates a process 300 which is an example of a process for providing image reservation and leasing in a virtual computing environment. The described operations may be accomplished using one or more of modules/sub-modules described herein and in some implementations, various operations may be performed in different sequences. In some implementations, additional operations may be performed along with some or all of the operations shown in FIG. 3. In some implementations, one or more operations may be performed simultaneously. In some implementations, one or more operations may be performed independently of the others. In some implementations, one or more of operations may not be performed. Accordingly, the operations described are exemplary in nature and, as such, should not be viewed as limiting.

In an operation 302, control module 204 via image reservation system 110 receives a request from a customer connected at a client device 106 to lease guest virtual machine 102 of cloud environment C1. In some implementations, guest virtual machine 102 is a protected image. A protected image is defined as a guest virtual machine that image reservation system 110 can control, for example, lock and unlock as needed. In some implementations, guest virtual machine 102 is unprotected. An unprotected image is a guest virtual machine that image reservation system 110 should ignore and allow running. In some implementations, the request from the customer includes a specific period of time for which guest virtual machine 102 is requested to be leased. In some implementations, the request may not include a specific period of time for which guest virtual machine 102 is to be leased, and rather there is an indication to lease guest virtual machine 102 for an indefinite period of time (also referred to as manual leasing). In some implementations, the customer uses image reserve module 104a for requesting the lease of guest virtual machine 102.

In an operation 304, in response to the request, control module 204 activates guest virtual machine 102 in cloud environment C1. In some implementations, prior to or in parallel with activation of guest virtual machine 102, control module 204 may verify credentials of the request and the customer. For example, control module 204 may perform authentication of the customer and may determine whether the request is a genuine request and not a malicious request from an automated malware agent intended to harm guest virtual machine 102 and/or cloud environment C1. If the customer is not authenticated, the request is denied. Activated guest virtual machines that are to be leased to customers are setup with an expiration time dependent upon the request from the customer, or dependent upon cloud environment C1. After a threshold period of time expires, automatic lock down of the leased guest virtual machine 102 occurs. In some implementations, the threshold time is programmable, for example, by an administrator of image reservation system 110. Guest virtual machine 102 (selected for activation by control module 204) is setup with a control agent 202 and provided to the customer via a client device 106. In some implementations, when an automatic activation of the leased guest virtual machine 102 is requested by a user at one of client devices 106, guest virtual machine 102 is automatically activated using image activation module 202a in control agent 202

In an operation 306, an electronic certificate associated with guest virtual machine 102 is created by use control monitor 204 during activation of the leased guest virtual machine 102. Generally, a certificate associated with guest virtual machine 102 includes metadata associated specifically with guest virtual machine 102 and information that validates the authenticity of guest virtual machine 102. By way of example only and not by way of limitation, such information can include information on guest virtual machine 102 (e.g., image identifier (ID)), information about the owner of guest virtual machine for customer authentication, user name and password, such that if the user needs to authenticate again, user data is compared with the information in the certificate to prove user's identity. Upon creation, the electronic certificate is provided to control agent 202 so that when leased guest virtual machine 102 is actively being used, the electronic certificate is used to connect to agent monitor control module 204d. The electronic certificate may be used by the customer to determine a current status of the leased guest virtual machine 102 based upon the electronic certificate. In some implementations, the electronic certificate of the leased guest virtual machine 102 may be utilized for determining status of clones of the leased guest virtual machine 102, e.g., whether they are valid, or obsolete. The certificate is managed by agent monitor control module 204d by performing various actions associated with the electronic certificate. Examples of such actions include generating the electronic certificate, or obtaining it back from control agent 202 if needed. After successful activation of the guest virtual machine 102, the certificate is sent to image control module 202b to be locally stored in control agent 202, in addition to storage in use control monitor 204. In some implementations, during activation the electronic certificate is provided to control agent 202, and inside image reservation system 104. In some implementations, some data from the electronic certificate and status of the guest virtual machine to be activated or leased is later available to the customer and used to control usage of the guest virtual machine. For example, the customer may get the data from the electronic certificate during activation of the guest virtual machine, and can store the data locally in one of client devices 106 if data associated with the electronic certificate stored at other locations is not available for some reason. In some implementations, this data may be used by the customer to gain access to use control monitor 204 directly without using the leased guest virtual machine (e.g., guest virtual machine 102) and unlock the guest virtual machine. In some implementations, after activation, a copy of the leased guest virtual machine (e.g., guest virtual machine 102) is available on server device 102, for example for backup purposes. When the guest virtual machine starts or becomes active, control agent 202 sends the electronic certificate to agent monitor control 204d. Based upon the received electronic certificate, agent monitor control 204d checks the status of the guest virtual machine and sends status information to control agent 202. In response, control agent 202 sends a default policy associated with the guest virtual machine that enables agent monitor control 204d to determine operations to be performed in case of exceptions that may arise during guest virtual machine use. Such policies can be modified directly on agent monitor control 204

In an operation 308, the requested guest virtual machine 102 is provided for use by a customer connected at client server device 102. In some implementations, this may be accomplished by control module 204 retrieving, in response to the request from server device 102, an active version of the requested image for use by a user at one of client devices 106. In some implementations, control module 204 also provides the certificate to the server device 102 indicating that a valid guest virtual machine is provided. The customer at one of client devices 106 connected to server device 102 may start using the provided guest virtual machine 102 and its associated services and applications after receipt.

In an operation 310, control module 204 monitors usage of the leased guest virtual machine 102 by the customer connected at server device 102 using time monitor module 204b.

In an operation 312, control module 204 determines whether or not the customer requested a release of the leased guest virtual machine 102 after an active period of use. In some implementations, if image end life module 104b is activated by a user using image activation module 202a but has not been deactivated prior to the release, the leased guest virtual machine 102 is automatically deactivated. Release of guest virtual machine 102 occurs when the customer at client device 106 requests use control module 204 that guest virtual machine 102 be locked or disposed, before the time that was indicated in the original request for leasing by the customer. For example, the release may occur when the customer is going on a vacation and will not use guest virtual machine 102 while on vacation. If yes, the flow proceeds to operation 316. If not, the flow proceeds to operation 314, for example, when a regular log-off request is received from the customer.

In an operation 314, control module 204 determines whether or not the active usage time of the leased guest virtual machine 102 is close to a predetermined threshold time allowed for the leased guest virtual machine 102 to be used. In some implementations, the predetermined threshold time may be in accordance with the provisions of the original request for lease received from the customer at one of client devices 106. The threshold time may be noted, for example, in the certificate associated with the leased guest virtual machine 102, as described herein, and communicated to time monitor module 204b for comparison with the actual time of active usage of the leased guest virtual machine 102. In some implementations, the threshold time is determined based upon the policies of the cloud vendor that leases guest virtual machine 102 (e.g., cloud environment C1).

In an operation 316, either based upon a release request received from client server device 102 or when the threshold time allowed for active usage of the leased guest virtual machine 102 has expired (or, is close to expiration), control module 204 locks guest virtual machine 102 from further usage. In some implementations, such locking of guest virtual machine 102 includes checking-in guest virtual machine 102 for optimizing data storage on cloud environment C1 and network resource use by other customers. In the locked state, time monitor module 204b stops keeping active time of usage. In some implementations, the period of time for which the leased guest virtual machine 102 is locked and is therefore inactive is indicated by the customer as part of the initial request (in operation 302). For example, the customer may know in advance when guest virtual machine 102 to be leased will not be actively used, and may indicate so in the initial request using image reservation system 104. In such implementation, the inactivity period is a planned parameter, and may be noted as part of the certificate issued at the time guest virtual machine 102 is provided for use to client device 106 (in operation 306).

In some implementations, control module 204 determines whether guest virtual machine 102 release request includes an image deactivation request. The deactivation request indicates that the leased guest virtual machine 102 will not be used anymore by the customer, and may be de-provisioned, as described herein. In some implementations, control module 204 carries out locking one or more backups of the leased guest virtual machine 102 in a memory device in control module 204 to prevent unauthorized usage of the backups. Backups of guest virtual machines may use the same electronic certificate as the leased guest virtual machine itself, and may contain a point-in-time snapshot of the leased guest virtual machine.

In an operation 318, control module 204 determines, after a period of time has elapsed since the last use of the leased guest virtual machine 102, whether a request for reuse of the leased locked image is received from the customer via server device 102. If no, based upon a further confirmation from the customer that originally requested the leasing of the guest virtual machine that guest virtual machine 102 is no longer needed, the flow proceeds to an operation 350. If yes, the flow proceeds to an operation 320.

In an operation 320, control module 204 determines a remaining portion of usage time of the leased guest virtual machine 102 for the customer connected using client device 106. Usage time is associated with eventual billing to the customer since the customer is only billed for the total usage time that is a sum of all usage times associated with the active usage of the leased guest virtual machine 102 by the customer. The information regarding remaining time can be obtained from time monitor module 204b that stores the usage time of the leased guest virtual machine 102 in a memory of server S1. In some implementations, if time limit does not expire and there is usage time remaining, image release and reapply module 110c keeps the leased guest virtual machine 102 in a state such that the leased guest virtual machine 102 can be reused (e.g., in a locked state). In some implementations, image release and reapply module 110c can also be used to reapply an guest virtual machine that was locked before (i.e., rented or leased again), authenticated again and then reactivated, optionally with another threshold time of expiration.

In an operation 322, control module 204 determines whether the previous active usage time for the leased guest virtual machine 102 (determined in operation 320) is close to or equals the total allowed time for which guest virtual machine 102 was leased. If yes, the flow proceeds to an operation 324. If not, the flow proceeds to an operation 328.

In an operation 324, when control module 204 determines that the last active usage time of the leased guest virtual machine 102 is close to the total allowed active usage time or has exceeded the total allowed time, control module 204 informs the customer regarding a requirement for an extension of usage time so that the customer can reuse guest virtual machine 102 according to the reuse request received in operation 318. In some implementations, such a notification is optional.

In an operation 326, control module 204 determines whether or not the customer has applied for an extension of time for reuse of the locked guest virtual machine 102. If not, based upon a further confirmation from the user that guest virtual machine 102 is no longer needed by the customer, the flow proceeds to operation 350. If yes, the flow proceeds to operation 328. In an implementation, the customer can automatically apply for an extension of reuse time along with the reuse request.

In an operation 328, control module 204 re-authenticates the reuse request for determining whether or not the same customer that was authorized to originally lease guest virtual machine 102 is requesting the reuse.

In an operation 330, control module determines whether the authentication of operation 328 has failed. The determination involves detecting one or more attempts to access the leased guest virtual machine 102 when the image was locked, for example. In some implementations, the determination is done with user authentication information and the electronic certificate associated with guest virtual machine 102. If not, the flow proceeds to an operation 334. If yes, the flow proceeds to operation 332.

In an operation 332, control module 204 generates an alert regarding unauthorized usage of the locked guest virtual machine 102 using image use control monitor store 204e. In some implementations, an alert is generated when the de-provisioned image is attempted to be run after deactivation. Deactivation is different from checking-in of the leased guest virtual machine 102 by the customer as described in operation 316. A deactivated guest virtual machine is a previously leased guest virtual machine that is no longer required for use by the customer and was de-provisioned. In this scenario, de-provisioning of the leased guest virtual machine 102 includes dissociating the customer with the leased guest virtual machine 102. Image control module 202b initiates on startup of image leasing system 110, connects to the agent monitor control module 204d and identifies that the guest virtual machine 102 was already deactivated. Control module 204 marks an alert inside the image use control monitor store 204e and sends the information back to the image control module 202b. Image control module 202b closes the image and an alert is sent if setup by the image use alert module 204b. In some implementations, image control module 202b can optionally be setup to warn customer about an attempt to access the deactivated guest virtual machine 102 but not to close the guest virtual machine 102. The flow then reverts to operation 326 where the alert is handled by again checking whether or not an extension for use of guest virtual machine 102 was applied by the actual authorized image user to whom guest virtual machine 102 was originally leased.

In an operation 334, when the reuse request has been authenticated by control module 204, control module 204 unlocks the locked leased guest virtual machine 102 and prepares the unlocked leased guest virtual machine 102 for provisioning to the customer. In some implementations, mounting or running the unlocked leased guest virtual machine 102 is carried out with an updated version of the leased guest virtual machine 102. For example, some clones or backups of guest virtual machine 102 may not reflect the most recent state of the leased guest virtual machine 102 when it was last used and checked-in. Accordingly, control module 204 does not mount such older backups of the leased guest virtual machine 102. In some implementations, the leased image is mounted after release. In this implementation, when an attempt to start the locked guest virtual machine 102 is made, image control 202b starts up on system startup, connects to agent monitor control module 204d, identifies the image state as locked, and prompts the customer user for reactivation. If not reactivated, guest virtual machine 102 shuts down and an alert is generated, as described in operation 332. The image is reactivated with a re-deployment process using image release and reapply module 104c by the customer connected at server device 102, which will change guest virtual machine 102's status on agent monitor control module 204d back to active and will allow guest virtual machine 102 to start up without a prompt for reactivation. Previously stored data associated with the leased guest virtual machine 102 is made available again to the customer upon reactivation. In some implementations, the leased guest virtual machine 102 is provided to the customer back in the same state that the previously leased or rented image ended with at deactivation by image end life module 110b. In some implementations, the status of guest virtual machine 102 is changed by image release and reapply module 104c to locked or unlocked on the server hosting the leased guest virtual machine 102 in cloud environment C1. For example, such change of status of the leased guest virtual machine 102 can occur with an action to either stop guest virtual machine 102 if it is still running when it locks, or when control agent 202 periodically asks for status requests to terminate guest virtual machine 102. In some implementations, with unlock image release and reapply module 110c can trigger the startup of guest virtual machine 102, or just allow it and wait for the customer to do the startup (which would have failed in locked mode).

In an operation 336, the mounted unlocked guest virtual machine 102 is again provided to the customer for use. Operation 336 includes processes similar to those carried out in operation 308.

In an operation 338, control module 204 monitors reuse time using time monitor module 204b, similar to the monitoring in operation 310.

In an operation 340, control module 204 determines whether or not the reuse time is close to exceeding the total allowed time for reuse of the leased guest virtual machine 102. In some implementations, this determination is carried out using at least one of reuse time and the usage time from previous usages of the leased guest virtual machine 102. If not, the flow proceeds to an operation 342. If yes, the flow proceeds to operation 348.

In an operation 342, control module 204 determines whether a release request or a log-off from the reuse of leased guest virtual machine 102 is received from server device 102. If yes, the flow proceeds to operation 344. If not, the flow goes back to operation 338 where the reuse of the leased guest virtual machine 102 is continued to be monitored.

In an operation 344, if a release request or log-off from the reuse of leased guest virtual machine 102 is received by control module 204, control module 204 relocks the leased guest virtual machine 102. In some implementations, control module 204 carries out relocking one or more backups of the leased guest virtual machine 102 in a memory of control module 204 to prevent unauthorized usage of the backups. The process of relocking is similar to the process of locking and checking-in of the leased guest virtual machine 102 as described in operation 316.

In an operation 346, control module 204 waits for a period of time before carrying out operation 350. The wait is performed to cover the implementation where the customer might request a reuse again. In some implementations, the wait time is programmable and is determined, for example, based upon a user's history of usage of a leased guest virtual machine, and then checking if an explicit request to end guest virtual machine use from the user is received.

In an operation 348, control module 204 notifies the customer at server device 102 that access to the leased guest virtual machine 102 is being ended. Such notification can be carried out via a GUI on a display of one of client devices 106, and may indicate that the leased guest virtual machine 102 will be terminated at an instance of time in future. In some implementations, operation 348 can be carried out prior to any operation that leads to de-provisioning or de-commissioning of the leased image (as shown in operation 350).

In an operation 350, control module 204 de-provisions the leased guest virtual machine 102. The de-provisioning involves locking any clones or backup copies of the leased guest virtual machine 102 such that unauthorized usage of those clones or backup copies can be prevented. In some implementations, de-provisioning involves ending, using control module 204, further access of the leased guest virtual machine 102 by customer at one of client devices 106 after the assigned total time has expired or after receiving a request from the customer to end the usage or the reuse by the customer. In some implementations, control module 204 carries out terminating the leased guest virtual machine 102 after the alert is generated. Terminating guest virtual machine 102 includes ordering image control module 202b to shut down guest virtual machine 102. When image was asked to be disposed, guest virtual machine 102 will not be able to start again after the shutdown, because it is also marked as locked. In some implementations, control module 204 can de-provision the leased guest virtual machine 102 using image activation/deactivation module 202a. An image de-provision request can be sent by image control module 202b to agent monitor control module 204d. Guest virtual machine 102 can then no longer be used, and will shutdown if a non-privileged user attempts to use it. In some implementations, control agent 202 may shutdown guest virtual machine 102 when control monitor 204 on the virtual appliance returns that guest virtual machine 102 has been deactivated, or has been locked and is not yet unlocked (which needs re-authentication).

In an operation 352, the customer connected at server device 102 is billed for a total active usage time of the leased guest virtual machine 102. The total active usage time of the leased guest virtual machine 102 is defined as the time of active usage when the leased image is not locked. In some implementations, it is also possible to bill the user beforehand for parts of use of guest virtual machine 102. In some implementations, when user knows of the full current use of guest virtual machine 102, the final bill for guest virtual machine 102 use is calculated and is available.

In an operation 354, using reports module 204c, control module 204 generates a report logging activities such as usage time, alerts, unauthorized attempts to use guest virtual machine 102, and the like. The report may be used by the customer for analysis and/or verification. Reports prepared using reports modules 204c includes information on images use status (activated/locked/deactivated) and alerts on guest virtual machine usage during locked or deactivation state, or in parallel to activated guest virtual machine. Such information includes guest virtual machine 102 and alert time to detect logs that attempt to start guest virtual machine 102 when locked, or a copy of the leased guest virtual machine 102 was attempted to be used.

In an operation 356, the flow ends.

It will be appreciated that the operations in FIG. 3 describe one or more exemplary implementations of the invention. However, various combinations of the operations may be used for other implementations, as will be appreciated by one of ordinary skill in the art, as also described in the examples below. Further, although in FIG. 3 a single request is described, cloud environment C1 hosting guest virtual machines can handle multiple requests from different users at different client devices 106 simultaneously and/or in parallel.

In some implementations, for example, the customer (also referred to as the customer) leases a virtual image for a limited time. A request to lease a protected guest virtual machine is opened by a customer for a specific time. The image control module 202b is installed on guest virtual machine 102 by cloud environment C1 before the consumer is allowed to use guest virtual machine 102. The customer requests guest virtual machine 102 for a specific period and activates it. Guest virtual machine 102 is then ready for use. On end of usage period, guest virtual machine 102 is locked, checked in, and is no longer usable. When another consumer (or an automatic procedure or agent) tries to use guest virtual machine 102 while it is still locked, an alert is triggered by image use alert module 204b. Cloud environment C1 monitors the alerts using image use alert module 204f and image status using image use control store 204e and can generate reports on the information gathered using reports module 204c. When the customer asks to use the same guest virtual machine 102 again, authentication is carried out and guest virtual machine 102 is setup to active state, allowing the customer to continue using guest virtual machine 102 with the data from previous use. Finally, the customer finishes using the environment, asks for guest virtual machine 102 end life, and guest virtual machine 102 is set to deactivate state. Now when someone attempts to get guest virtual machine 102 up (i.e., use guest virtual machine 102), an alert is triggered again which shuts down guest virtual machine 102. Next, guest virtual machine 102 is disposed of including all the backups and clones.

In some implementations, for example, billing enforcement of actual usage time is carried out using time monitor module 204b. In this example implementation, a customer leases an guest virtual machine from the cloud provider, uses the guest virtual machine, and releases it. The guest virtual machine is expired and locked, and the billing process stops. A system administrator inadvertently tries to start the locked guest virtual machine. Because the guest virtual machine is locked, an inadvertent billing is prevented, and alert is sent to the cloud environment C1. The cloud environment C1 runs dormant images report using reports module 204c and finds the dormant guest virtual machine. Upon checking with the customer, cloud environment C1 finds the guest virtual machine is no longer needed and disposes it, billing the consumer only for actual use of the leased guest virtual machine, and also releasing resources in environment 100 (e.g., resources at client devices 110).

In some implementations, for example, an image clone may be used in parallel. In this example implementation, the cloud customer leases an guest virtual machine for certain time, the guest virtual machine is activated and is now ready for use. A clone is taken from the guest virtual machine for backup purpose or other regular use by control module 204. When someone attempts to mount the guest virtual machine using one of its clones, the agent detects this guest virtual machine is in use and generates an alert for parallel use of an active guest virtual machine. Further, when image use period expires and now someone attempts to use the clone, attempt is blocked because it was not unlocked prior to the clone being used. To use the clone, the original guest virtual machine is first unlocked, and then the usage transferred from the original guest virtual machine into the clone, making sure that the usage is for valid purposes.

Accordingly, various implementations of the invention provide solutions for allowing leasing of images for a limited period, locking them automatically on end/intermediate phases of use periods, and preventing un-privileged usage or extraction of information while the image is idle.

Implementations described in this disclosure may be made in hardware, firmware, middleware, software, or various combinations thereof. The technology disclosed herein may also be implemented as computer-readable instructions stored on a tangible computer-readable storage medium which may be read and executed by one or more processors. A computer-readable storage medium may include various mechanisms for storing information in a form readable by a computing device. For example, a tangible computer-readable storage medium may include optical storage media, flash memory devices, and/or other storage mediums. Further, firmware, software, routines, or instructions may be described in the above disclosure in terms of specific exemplary aspects and implementations of the technology, and performing certain actions. However, it will be apparent that such descriptions are merely for convenience, and that such actions may in fact result from computing devices, processors, controllers, or other devices executing firmware, software, routines or instructions.

Other implementations, uses, and advantages of the disclosed technology will be apparent to those skilled in the art from consideration of the specification and practice of the invention disclosed herein. The specification should be considered exemplary only, and the scope of the technology disclosed herein is accordingly intended to be limited only by the following claims.

What is claimed is:

1. A method for securing leased images in a cloud environment, comprising:
monitoring a usage of a leased image provided by a cloud vendor, by a client computing device;
determining a threshold period of time associated with the usage;
determining whether an access to the leased image should be terminated based upon an expiry of the threshold period of time or based upon a request received from the client computing device;
locking the image based upon the determining whether the access to the leased image should be terminated;
monitoring an access request received for the locked image; and
enabling access to the locked image when it is determined that the access request is valid.

2. The method of claim 1 further comprising:
unlocking the locked leased image in response to the request; and
continuing the monitoring of the reuse of the leased image after the unlocking, wherein the access request is a reuse request of the locked image.

3. The method of claim 2 further comprising:
determining whether at least one of the usage and the reuse of the leased image has exceeded a total time assigned for the leased image;
ending further access of the leased image by the client computing device after the assigned total time or after receiving a request from the client computing device to end the usage or the reuse; and
relocking the leased image to prevent subsequent usage.

4. The method of claim 2, wherein the unlocking comprises:
authenticating the client computing device such that an alert is generated when the authenticating fails;
obtaining, from the cloud vendor, the leased image; and
mounting the updated version of the leased image for the reuse by the client computing device.

5. The method of claim 1 further comprising:
billing the client computing device for a total usage time defined as a time period for which the leased image is actively used by the client computing device when the leased image is not locked.

6. The method of claim 1 further comprising:
receiving prior to the monitoring the usage, a request from the client computing device to lease an image from a cloud vendor;
receiving in response to the request, an active version of the requested image;
creating an electronic certificate associated with the requested image, wherein the electronic certificate includes a verification of authenticity of the received active version of the requested image; and
providing the verified active version of the image as the leased image to the client computing device.

7. The method of claim 1 further comprising:
detecting one or more attempts to access the leased image when the image was locked;
generating an alert in response to the detecting; and
terminating the leased image after the generating.

8. The method of claim 7, wherein the locking comprises:
locking one or more backups of the leased image in a memory device in the control module to prevent unauthorized usage.

9. The method of claim 1 further comprising:
generating a report of a status of the leased image including information related to active images associated with the client computing device, locked images associated with the client computing device, and for each one of the active and locked images, a period of time for which the active and the locked images have been used by the client computing device, and whether or not another client computing device attempted to activate the locked images.

10. A tangible computer-readable storage medium having one or more computer-readable instructions thereon for securing leased images in a cloud computing environment, which when executed by one or more processors cause the one or more processors to:
monitor a usage of a leased image provided by a cloud vendor, by a client computing device;
determine a threshold period of time associated with the usage;
determine whether an access to the leased image should be terminated based upon an expiry of the threshold period of time or based upon a request received from the client computing device;
lock the image based upon whether the access to the leased image should be terminated;
monitor an access request received for the locked image; and
enable access to the locked image when it is determined that the access request is valid.

11. The tangible computer-readable storage medium of claim 10, wherein the one or more computer-readable instructions when executed by one or more processors further cause the one or more processors to:
unlock the locked leased image in response to the request; and
continue the monitoring of the reuse of the leased image after the unlocking, wherein the access request is a reuse request of the locked image.

12. The tangible computer-readable storage medium of claim 11, wherein the one or more computer-readable instructions when executed by one or more processors further cause the one or more processors to:
determine whether at least one of the usage and the reuse of the leased image has exceeded a total time assigned for the leased image;
end further access of the leased image by the client computing device after the assigned total time or after receiving a request from the client computing device to end the usage or the reuse; and
relock the leased image to prevent subsequent usage.

13. The tangible computer-readable storage medium of claim 11, wherein the one or more computer-readable instructions when executed by one or more processors cause the one or more processors to unlock by:
authenticating the client computing device such that an alert is generated when the authenticating fails;
obtaining, from the cloud vendor, the leased image; and
mounting the updated version of the leased image for the reuse by the client computing device.

14. The tangible computer-readable storage medium of claim 10, wherein the one or more computer-readable instructions when executed by one or more processors further cause the one or more processors to:
bill the client computing device for a total usage time defined as a time period for which the leased image is actively used by the client computing device when the leased image is not locked.

15. The tangible computer-readable storage medium of claim 10, wherein the one or more computer-readable instructions when executed by one or more processors further cause the one or more processors to:
receive prior to the monitoring, a request from the client computing device to lease an image from a cloud vendor;
receive in response to the request, an active version of the requested image;
create an electronic certificate associated with the requested image, wherein the electronic certificate includes a verification of authenticity of the received active version of the requested image; and
provide the verified active version of the image as the leased image to the client computing device.

16. The tangible computer-readable storage medium of claim 10, wherein the one or more computer-readable instructions when executed by one or more processors further cause the one or more processors to:
detect one or more attempts to access the leased image when the image was locked;
generate an alert in response to the detecting; and
terminate the leased image after the generating.

17. The tangible computer-readable storage medium of claim 16, wherein the one or more computer-readable instructions when executed by one or more processors that cause the one or more processors to lock by:
locking one or more backups of the leased image in a memory device in the control module to prevent unauthorized usage.

18. The tangible computer-readable storage medium of claim 10, wherein the one or more computer-readable instructions when executed by one or more processors further cause the one or more processors to:
generate a report of a status of the leased image including information related to active images associated with the client computing device, locked images associated with the client computing device, and for each one of the active and locked images, a period of time for which the active and the locked images have been used by the client computing device, and whether or not another client computing device attempted to activate the locked images.

19. An image leasing system configured to secure leased images in a cloud computing environment, the image leasing system comprising one or more processors configured to:
monitor a usage of a leased image provided by a cloud vendor, by a client computing device;
determine a threshold period of time associated with the usage;
determine whether an access to the leased image should be terminated based upon an expiry of the threshold period of time or based upon a request received from the client computing device;
lock the image based upon whether the access to the leased image should be terminated;
monitor an access request received for the locked image; and
enable access to the locked image when it is determined that the access request is valid.

20. The image leasing system of claim 19, wherein the one or more processors are further configured to:
unlock the locked leased image in response to the request; and
continue the monitoring of the reuse of the leased image after the unlocking, wherein the access request is a reuse request of the locked image.
